(19) United States
(12) Patent Application Publication
(10) Pub. No.: US 2007/0171888 A1
(43) Pub. Date: Jul. 26, 2007

(54) Method and apparatus for establishing a wireless communications network solar powered access points

(76) Inventor: Benjamin Joseph Adams, Boulder, CA (US)

Correspondence Address: MUELLER AND SMITH, LPA;MUELLER-SMITH BUILDING, 7700 RIVERS EDGE DRIVE, COLUMBUS, OH, 43235, US

(21) Appl. No.: 11/655,536

(22) Filed: Jan. 19, 2007

Related U.S. Application Data
(60) Provisional application No. 60/760,681, filed on Jan. 20, 2006.

(51) Int. Cl. H04J 3/16

(52) U.S. Cl. 370/346

(57) ABSTRACT

The present invention is addressed to method and apparatus for establishing a wireless communications network utilizing portable solar powered access points. Each access point includes a solar panel connected to a base unit containing-one or more charge storage assemblies. A charge controller controls the recharging of the charge storage assemblies. Also contained within the base unit is an access point. A voltage control device controls the flow of electrical charge from the charge storage assemblies to the access point. On the exterior of the base unit is a weatherproof connector for connecting the solar panel to the base unit. Another weatherproof connector is provided on the exterior of the base unit for connecting an antenna, which sends and receives radio transmissions within a basic service area. Yet another weatherproof connector is provided to enable the base unit to be connected to an existing wired network, if desired.

### CROSS-REFERENCE TO RELATED APPLICATIONS

This application claims the benefit of provisional Application No. 60/760,681, filed Jan. 17, 2006, the disclosure of which is hereby incorporated by reference.

### STATEMENT REGARDING FEDERALLY SPONSORED RESEARCH

Not applicable.

### BACKGROUND OF THE INVENTION

On Aug. 29, 2005, Hurricane Katrina made landfall near Buras-Triumph, Louisiana as a strong Category 3 storm with sustained winds of approximately 125 miles per hour. Hurricane Katrina was the most destructive and costliest natural disaster in the history of the United States and the deadliest since the 1928 Okeechobee Hurricane. To date, the official death toll stands at 1383 and, as of Dec. 20, 2005, more than 4000 people remain unaccounted for and many of these people are feared dead. The National Hurricane Center estimates that damage caused by Hurricane Katrina is about $75 billion dollars.

Much of the damage resulted from the breach of the levee system in New Orleans, Louisiana after which 80% of the city was underwater. Many residents were trapped in the city with no food or water. Widespread looting and violence broke out and the governor of Louisiana ordered the city evacuated. The states of Louisiana, Mississippi and Alabama were declared a major disaster. The disaster area covered about 90,000 square miles, a geographic extent almost as large as the United Kingdom. Fear of disease from stagnant flood waters led the Gulf Coast to be declared a Public Health Emergency.

Rescue and recovery efforts were severely hindered by Hurricane Katrina's damage to the affected area's communications network. According to the Office of Electricity Delivery and Energy Reliability (OE), some 2.6 million customers reported loss of power due to the storm. Office of Electricity Delivery and Energy Reliability (OE), U.S. Department of Energy, Hurricane Katrina Situation Report #11 dated Aug. 30, 2005. As of the date of the report, about 42% of the State of Louisiana and 64% of the State of Mississippi were without power. The report cited extensive flooding as a major issue for electricity restoration and determined that the size of the hurricane, the extensive physical damage to property and the number of utilities impacted would significantly slow the speed of restoration efforts.

In affected areas, there was a virtually total internet disruption, as locally hosted servers and routers went down with the loss of primary and backup power. Hurricane Katrina also heavily damaged Lake Pontchartrain Causeway, a key telecommunications link which had a conduit for power and fiber-optic lines. Katrina also affected cell phone communications. High winds damaged cell towers and other facilities that house the cites that transmit calls. The failure of the power system robbed cell providers of the electricity needed to run cell sites, and floodwaters isolated many cell sites making it impossible to repair them. Damage to landlines also crippled cell providers operating in the affected areas. According to one spokesman for a major cell phone service provider, “What you had down there was essentially an apocalypse.” In a time of crisis, millions of people lacked phone service of any kind.

Rescue workers, officials and law enforcement officers also were crippled by the loss of power and telecommunications. So long as wireless networks remained down, State and Federal officials were unable to use hand-held communication devices. New Orleans's police department's citywide 800 MHz radio system went down as power was disrupted and transmitter sites for the police radio system were underwater and disabled. During the aftermath of the storm, Louisiana Governor, Kathleen Bianco was quoted as saying, “The communications network is completely gone” According to a memorandum from the Homeland Security Department, “the telecommunications infrastructure in New Orleans, Biloxi, and Gulfport is considered to be a total write-off.”

Most wireless networks are based on the 802.11 standard promulgated by the Institute of Electronics and Electrical Engineers (IEEE). Under this standard, portable devices containing wireless interfaces, referred to as stations, transmit data via radio waves operating in particular frequency bands. For example, a device having an 802.11a interface transmits data in the 5 Ghz frequency band at speeds of up to 54 megabits per second (Mbps). A device having an 802.11b or 802.11g interface transmits data in the 2.4 GHz frequency band at speeds of up to 11 MBPS and 54 MBPS, respectively. Stations generally are battery operated devices such as laptops, cell phones, PDAs, etc. By establishing an infrastructure network, stations can communicate with one another if located within a defined geographic location. The basic building block of an infrastructure network is an access point. An access point includes a wireless network interface that enables the access point to communicate with stations having a wireless network interface. The stations with which the access point communicates are referred to as the basic service set (BSS) and the basic service area is the geographic area in which wireless devices must be located in order for the wireless device to communicate with the access point. The extent of the basic service area is determined by the propagation characteristics of the wireless medium, e.g., the radio waves. Rather than stations communicating directing with one another, an access point controls all communications among stations located within the basic service area.

Using a plurality of access points and a backbone network, one can create an extended service set network (ESS) which enables stations in different basic service areas to communicate with one another. All the access points within an extended service area will share the same service set identifier (SSID), which is the network name. In addition to a wireless network interface, access points also generally include an Ethernet network interface that can be connected to an existing wired network so that the wireless side of the access point becomes an extension of the existing wired network. The wired network is referred to as the backbone network. Thus, for example, if the wired network has access to the Internet via a router, the stations may connect to the Internet through the appropriate access point. A distribution system connects access points within an ESS and ensures that data is delivered to the proper access point where it is relayed to the intended destination (e.g., the proper station). A distribution system consists of a distribution system medium and a bridging engine. The functions of the distribution system medium may be provided by the backbone network or the access points may include a wireless distribution system (WDS) which acts as the distribution system medium. The bridging engine controls the exchange of data between the wired and wireless interfaces of the access points.

For more information on wireless networking, see:

Gast, Matthew S. 802.11 Wireless Networks. Sebastopol:

O'Reilly, 2005.

In establishing wireless networks, one of the main problems is supplying power to the access points. This is problematic both from an installation and an operation stand point. When installing an access point, for example, on the roof of a building, the installer must first obtain a site inspection to determine where the access point can be positioned in order for the existing structure to provide the proper electrical connection. If the proper electrical connection is not readily available, then the installer must obtain the services of a certified technician, such as an electrician, to install outlets where each access point is deployed. Site surveys, particularly those that require the services of an electrician, are both time consuming and expensive. Once installed, disruptions in the power supply will result in disruptions of the wireless network. This is true even for access points that utilize Power over Ethernet (PoE) technology to supply power over the same Category 5/5e twisted-pair cable that carries Ethernet data. Power outage was a primary cause of the failure of wireless networks following Hurricane Katrina.

### BRIEF SUMMARY OF THE INVENTION

The present invention is addressed to method and apparatus for establishing a wireless communications network utilizing portable solar powered access points. Each access point includes a solar panel that generates electrical energy. The solar panel is connected to a base unit containing one or more charge storage assemblies, such as batteries. A charge controller controls the recharging of the charge storage assemblies. Also contained within the base unit is an access point. A voltage control device controls the flow of electrical charge from the charge storage assemblies to the access point. On the exterior of the base unit are weatherproof connectors for connecting the solar panel and an antenna, which sends and receives radio transmissions within a basic service area. Yet another weatherproof connector is provided to enable the base unit to be connected to an existing wired network, if desired.

The method of the present invention addresses establishing a portable solar powered wireless communications network within a given region for generating an extended service area in association with an existing wired communications network to enable communications among wireless devices located within the given region. For example, the given region may be selected commensurate with any purpose, such as disaster relief, military, public access, recreational, residential, agricultural, educational, scientific, environmental, etc. The first step in establishing the wireless network is providing a plurality of solar powered access points. Prior to deploying the access points, they may be stored in a storage facility. To maintain the charge of the charge storage devices, the solar powered access points may be connected to a charge maintenance assembly, such as a trickle charger. When the network is desired to be established, the portable access points are transported to the given area. A first solar powered access point is appropriately positioned and connected to a wired communications network. A plurality of solar powered access points then are positioned within the given region with the basic service areas of said first solar powered access point and the plurality of solar powered access points overlapping to define an extended service area. A wireless distribution system associated with the first solar power access point and the plurality of solar powered access points is provided for controlling radio transmissions within the extended service area.

### BRIEF DESCRIPTION OF THE DRAWINGS

For a fuller understanding of the nature and advantages of the present invention, reference should be had to the following detailed description taken in connection with the accompanying drawings, in which:

FIG. 1 is a perspective view of a portable solar powered access point with a connected omni-directional antenna;

FIG. 2 is another view of the portable solar powered access point of FIG. 1 and further showing the components of the access point in block diagrammatic form;

FIG. 3 is an illustrative design for an infrastructure extended service set using solar powered access points throughout the city of New Orleans, La. US;

FIG. 4 is a perspective view of the portable solar powered access point of FIG. 6 in a transport configuration;

FIG. 5 is a perspective view of 18 portable solar powered access points stored on a rack and ready for deployment;

FIG. 6 is another embodiment of a solar powered access point including a pair of omni-directional antennas and a pair of solar panels;

FIG. 7 is a perspective view of a portable solar power access point connected to a satellite antenna;

FIG. 8 is a perspective view of a portable solar power access point connected to a back haul;

FIG. 9 is a perspective view of a conventional omni-directional antenna;

FIG. 10 is a perspective view of a conventional sector antenna;

FIG. 11 is a perspective view of a conventional directional antenna;

FIG. 12 is a diagram illustrating the basic service areas within which a portable solar powered access point with an omni-directional antenna can transmit data to various receiving devices;

FIG. 13 illustrates the extended service area generated by a pair of portable solar powered access points each connected to an omni-directional antenna;

FIG. 14 illustrates the extended service area generated by a pair of portable solar powered access points, one connected to an omni-directional antenna and the other connected to a sector antenna;

FIG. 15 is a perspective view of a pair of portable solar powered access points, each connected to a back haul for long range transmission of data to a backbone network;

FIG. 16 is a perspective view of a pair of solar powered access points, each with a directional antenna;

FIG. 17 illustrates an infrastructure extended service area generated by 7 solar powered access points with omni-directional antennas and a pair of solar powered access points each connected to a back haul;

FIG. 18 illustrates an infrastructure extended service area generated by 7 solar powered access points with omni-directional antennas and a pair of solar powered access points each connected to a satellite antenna;

FIG. 19 shows an infrastructure extended service area generated by 7 solar powered access points with omni-directional antennas and a pair of solar powered access points each connected to a directional antenna;

FIG. 20 is a perspective view of a portable solar powered access point with an omni-directional antenna located on the roof of a building; and

FIG. 21 is an overhead view of the solar powered access point of FIG. 20 and shows the basic service area generated among six buildings.

### DETAILED DESCRIPTION OF THE INVENTION

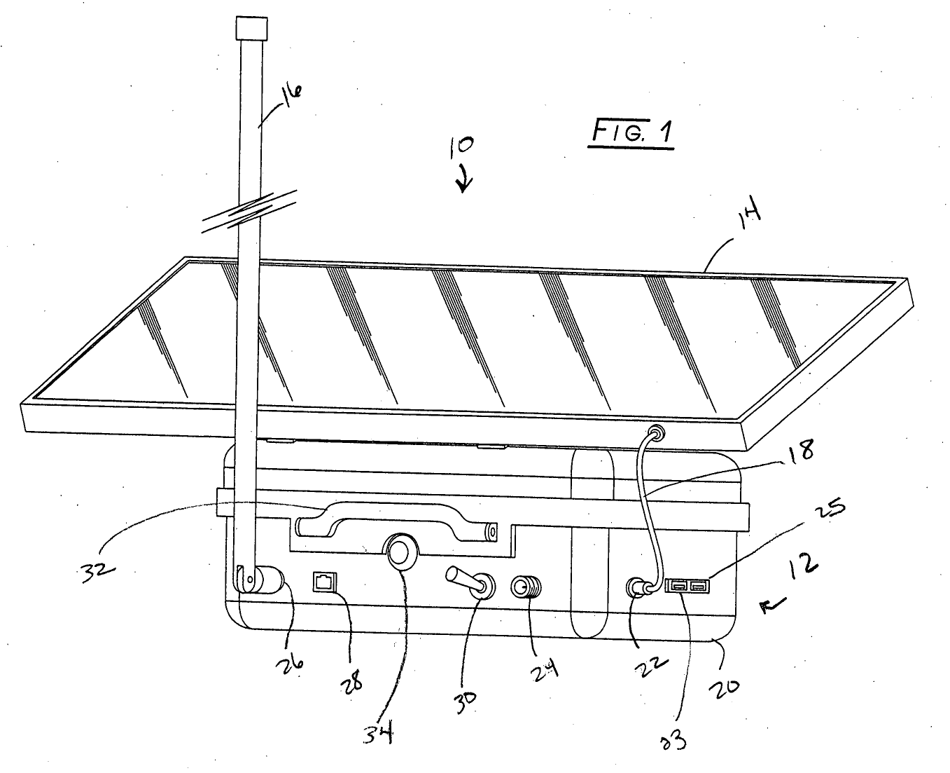

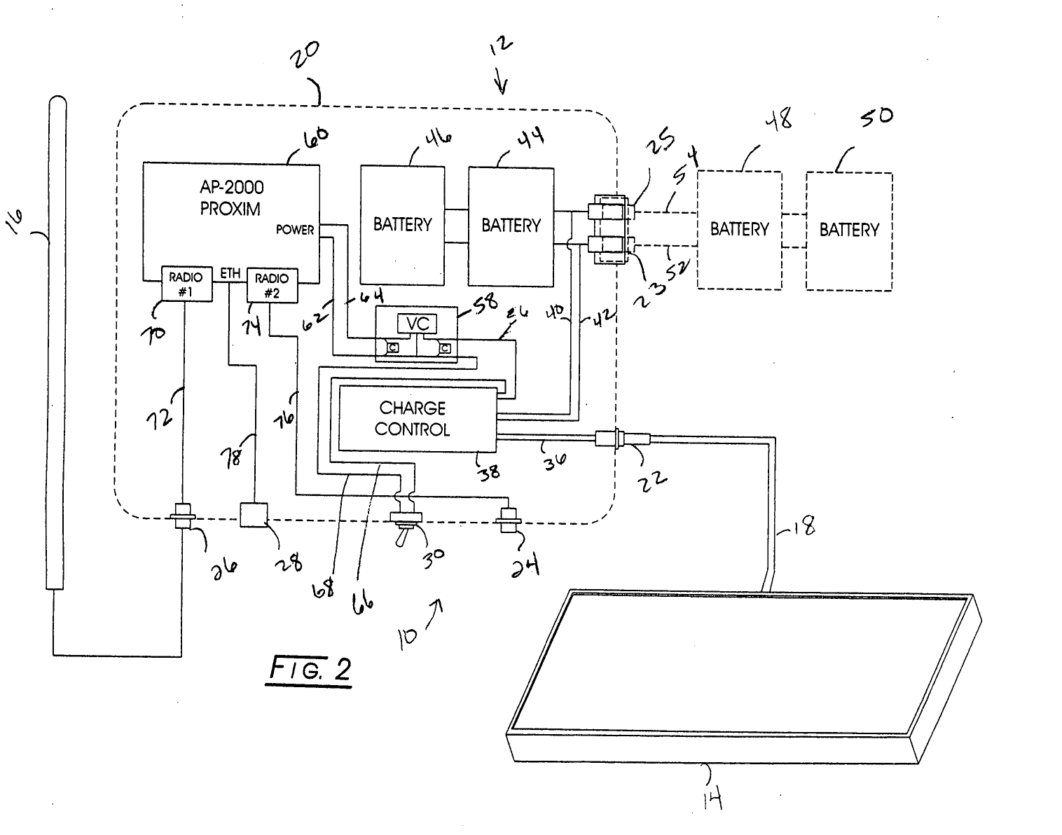

The present invention is addressed to method and apparatus for establishing a wireless network with portable solar powered access points. Looking to FIG. 1, a portable solar powered access point is shown generally at 10. Solar powered access point 10 is seen to include a base unit shown generally at 12, a solar panel 14, and an omni-directional antenna 16. Solar panel 14 provides electrical charge to base unit 12 via a cable 18 which is secured to the housing 20 of base unit 12 by a weatherproof bulkhead solar panel connector 22. Such a connector is manufactured by Woodhead Industries Inc. of Deerfield, Ill. Solar panels, such as those described, are manufactured, for example, by BP Solar International, Inc. of Frederick, Md., GE Energy of Atlanta, Ga. and Shell Solar Industries of Camarillo Calif. To the right of connector 22 is a pair of connectors for attaching additional charge storage assemblies, as will be described in greater detail in connection with FIG. 2. Housing 20 of base unit 12 also includes a pair of N-type bulkhead waterproof antenna ports, 24 and 26. N-type bulkhead waterproof antenna ports are manufactured by Woodhead Industries Inc. of Deerfield, Ill. An omni-directional antenna is seen to be connected to connector 28. Located between antenna connectors 24 and 26 is a sealed Rj-45 connector, 28, which enables the access point to be connected to a wired network by a conventional category 5 cable (not shown). Such a waterproof connector is manufactured, for example, by Woodhead Industries Inc. of Deerfield, Ill. under the trade name “RJ-Lnxx.” Also located between antenna connectors and an on/off switch, 30. Housing 20 is seen to include a carrying handle, 32, and a latch 34. To provide portability, solar powered access point 10 generally will be no larger than 1 cubic foot weighing no more than 50 pounds.

FIG. 2 reveals the internal components of base unit 12 in block diagrammatic fashion. Components previously identified in FIG. 1 retain their prior numeration. Electrical charge generated by solar panel 14 is transmitted to a charge controller, 38, via line 36 and then to charge storage assemblies, such as batteries 44 and 46 via lines 40 and 42. Batteries 44 and 46 may be lead acid batteries, such as Absorption Glass Mat (AGM) batteries manufactured by MK Battery of Anaheim, Calif. Charge controller 38 prevents batteries 44 and 46 from overcharging. Additional batteries, such as the two shown at 48 and 50 may be provided in daisy chain fashion to store additional charge from solar panel 14. Batteries 48 and 50 are connected to base unit 12 via connectors 23 and 25 (FIG. 1) and as indicated by lines 52 and 54. Charge controller 38 also is connected via line 56 to a voltage controller 58. Voltage controller 58 also is connected to access point, 60, as indicated at lines 62 and 64. On/off switch 30 is seen to be connected to charge controller 38 via line 66 and voltage controller 58 via line 68. When actuated to the “on” position, electrical charge from batteries 44 and 46 are supplied to access point 60.

Clearly, for the access point described above, the type and number of solar panels and batteries may vary. To determine the proper solar panel/battery configuration, one must first take into account the power draw of the access point to establish how much power is required. The batteries total capacity and discharge rate also must be considered. Finally, the solar panel(s) ability to recharge the batteries must be taken into account. The solar panels energy production will be a function of the solar panel itself as well as the weather conditions to which the solar panel will be exposed.

With its solar powered configuration, access point 60 does not require connection to an electrical outlet which gives the access point a freedom of mobility not realized by other access point designs. This configuration also insulates the access point from power supply disruptions such as high and low voltage spikes, surges, and brown-outs, as well as complete power supply outages. In the event of a catastrophic disaster, such as Hurricane Katrina, the power outage may be sustained over a relatively long period of time. Access point 60 also is particularly valuable in places, such as third world countries and some rural areas in industrialized countries, where a power supply is simply unavailable or where the established power supply is frequently interrupted. Access point 60 also may be valuable where use of the existing power supply is not cost effective.

Looking again to FIG. 2, access point 60 includes a first radio, 70, connected to antenna 16 via connector 26 as indicated at line 72. This radio may operate, for example at 2.4 GHz for 802.11g and 802.11b communications. Access point 60 also contains a second radio, 74. When connected to a second antenna (not shown) via connector 24 as indicated at line 76, radio 70 may operate at 5.0 GHz for 802.11a communications. Access point 60 also may be connected to a wired network via RJ-45 connector 28 as indicated by line 78. An access point having the features described above is manufactured, for example, by Proxim Corporation, of San Jose, Calif., under the trade name “ORiNOCO AP-2000.”

Using a plurality of access points, such as that described at 60 in connection with FIGS. 1 and 2, one can quickly and easily establish a solar powered wireless network within a given region. The given region may be any geographic area whose periphery is selected commensurate with the purpose of the network. For example, emergency response organizations, such as FEMA, the International Red Cross, mobile clinics, etc., may establish a network in a disaster region or an accident region. For military applications, a military region might constitute a military base or field operation. The network also may be used for border protection and surveillance. As another example, the given area may be a public access area selected as a value added amenity for customers in malls, public parks, or other public domains. Commercial establishments may select a recreational region such as a golf course, marina, resort, outdoor sporting event, campsite, national park, etc. Industrial applications may include industrial backwoods operations, shipyards, railways, oil and gas fields, etc. A residential region might constitute, for example, an apartment or condominium complex, housing development, off-grid community, reservation, college dormitory, trailer park, and the like. An agricultural region may be selected for areas, such as, ranches, farms, vineyards, groves, and orchards. As yet another example, the given region may be an educational region encompassing public and private schools, or public and private colleges and universities. A scientific region may be established, for example, for a research station or field project. Within an environmental region, the network can provide remote monitoring and data acquisition for regulatory or health and safety compliance. A security region may be established for remote monitoring, remote alarming, video networking with data back-up, etc. An outdoor region may be established for permanent or temporary events such as expos, farmer's markets, outdoor competitions, such as marathons and triathlons, concerts, festivals, etc. An outdoor region may also extend over mountaineering base camps, fishing and hunting camps, kayaking, climbing or diving outfitters, etc. A transportation region may be selected along local and interstate highways, airports, parking lots, etc. As can be seen from the foregoing examples, the given area may be located in any geographic area for any purpose.

FIG. 3 is an illustration of a wireless network encompassing a disaster region, specifically, the city of New Orleans, La. This implementation utilizes 15 access points, 92-118, spaced about the city. All of the access points, except 96 and 112, have at least one omni-directional antenna which radiates power uniformly in all directions and provides a basic service area of about 5 miles. Access points 96 and 112 are connected to a satellite dish antenna, which is a type of parabolic antenna designed with the specific purpose of transmitting signals to and/or receiving signals from a satellite. Using these satellite links, the established wireless network is connected and becomes an extension of a remotely located wired network. For redundancy purposes, a pair of back hauls may be provided to establish connection of the wireless network with an existing wired network location, such as Baton Rouge which is shown generally on the map at 124. This back-up connection is indicated by arrows, 120 and 122. Each of the access points does not have to be connected to the wired network if the access points include a wireless distribution system. This is true regardless of whether the wireless network is connected to a wired network by a satellite or back haul connection.

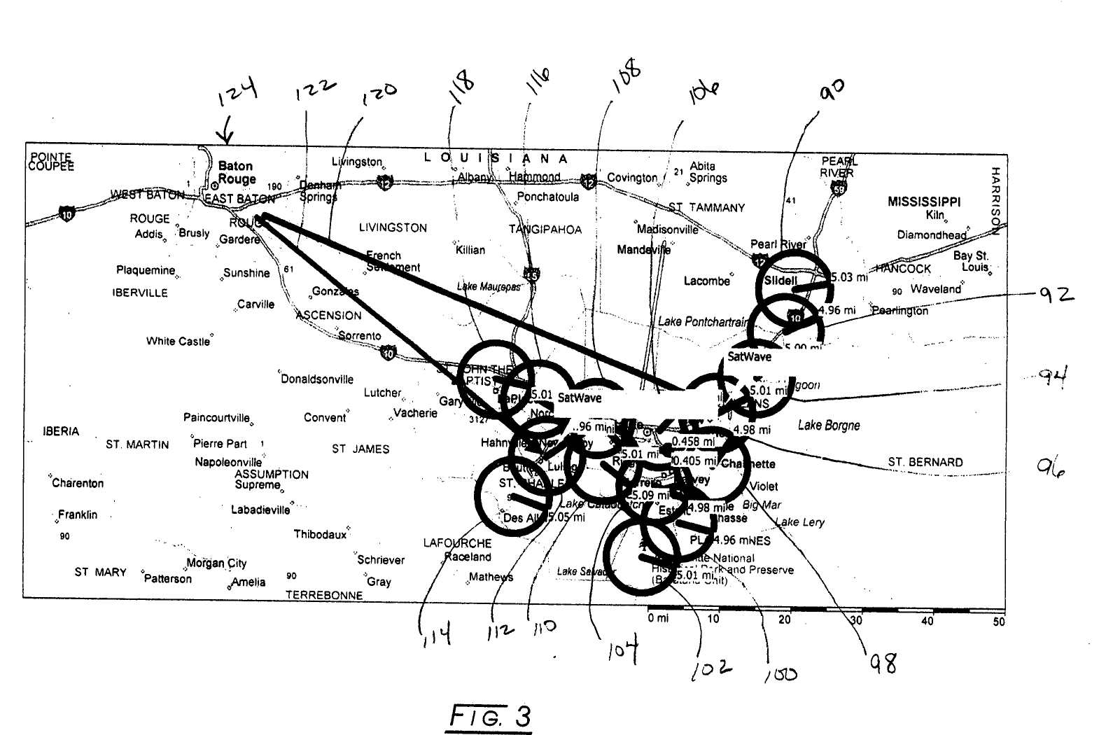

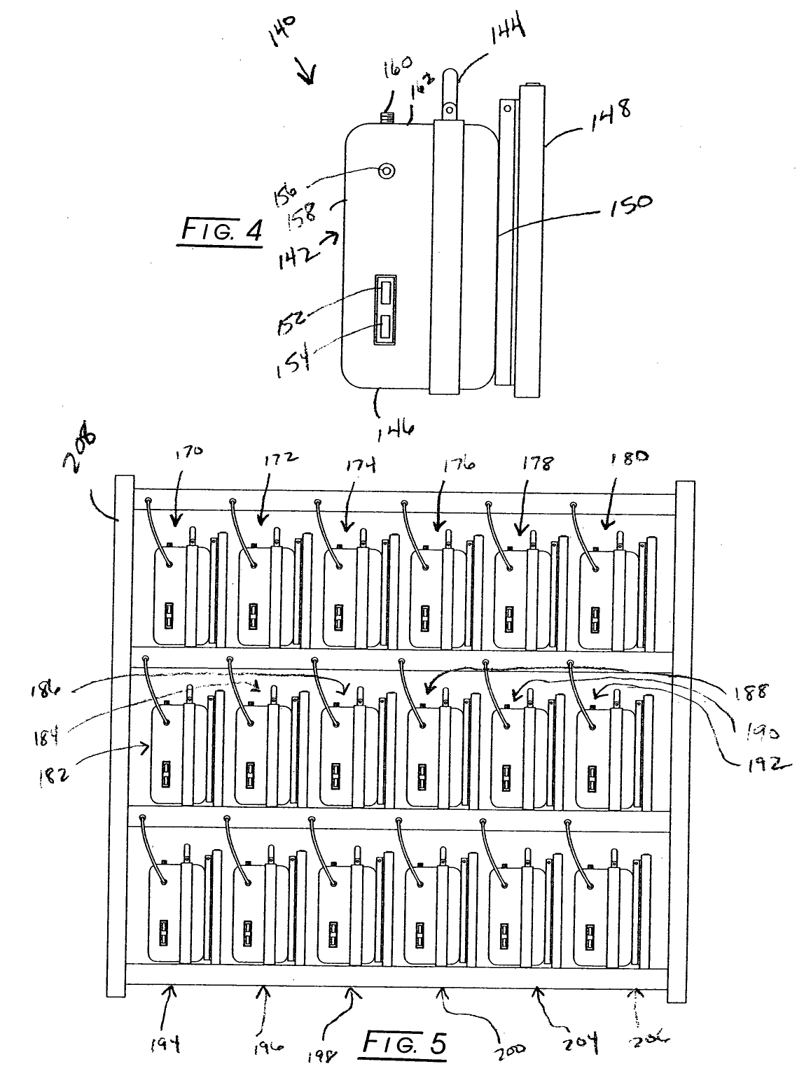

Prior to deployment, the portable solar powered access points of the present invention may be stored and transported in the convenient configuration shown in FIG. 4. In that figure, an access point, 140, is shown with base unit 142 in an upstanding position so that the handle, 144, of housing 146 may be easily grasped for carrying. Solar panel 148 also is seen to be in an upright position abutting the surface 150 of base unit housing 146. In this configuration, all of the connectors are located either on the side or top of housing 146. For example, battery connectors 152 and 154 and solar power connector 156 are located on side 158, while antenna connector 160 is seen to be located on the top 162 of housing 146. With this configuration, many access points can easily be stored in a warehouse in preparation for deployment. FIG. 5 shows eighteen access points, 170 to 206, positioned on three shelves of a rack, 208. Each access point 170 to 206 is electrically connected by a wire to a trickle charger (not shown) associated with rack 208. While being stored on rack 208, the trickle charger supplies an electric charge to the batteries contained within the access points at a continuous low rate to keep them fully charged. This ensures that the access points' batteries are fully charged when the access points are deployed from the warehouse.

In an emergency situation, the desired number of access points are transported from the storage warehouse to the site where the wireless network is to be established. Because of their relatively small size and light weight, a large number of access points can easily be transported by truck, airplane, helicopter, etc. Using a laptop with conventional mapping software, one can quickly and easily determine the number of access points needed to provide wireless coverage for a specific geographic area. Topology software also may be used to determine the most effective positioning of the access points within the disaster area. For example, in the scenario presented in FIG. 3, 15 solar powered access points will effectively cover the city of New Orleans and certain outlying areas. Because the access points are solar powered and utilize a wireless distribution system, power outlets and wired network connections are not an issue. This enables the access points to be positioned anywhere in the disaster area. Once the proposed network has been designed, the selected number of access points are configured with the network name, or service set identifier (SSID), the TCP/IP addresses of the access points, and the MAC address for the wireless distribution system. Having configured the system, the access points are positioned about the disaster area and turned on by flipping the on/off switch, as at 30 in FIG. 1. No additional installation steps are required; however, if desired, the access points may be secured in position and structurally buttressed using a tripod or other mechanism. Once the network has been established, it may be monitored and administered remotely via the Internet or an existing wired network. For the New Orleans network shown in FIG. 3, such a connection is provided via satellite links as at 96 and 112. Additional access points may easily be added and remotely configured with the SSID, TCP/IP addresses and MAC address of the established network.

FIG. 6 illustrates an alternative access point embodiment shown generally at 250. Access point 250 includes a base unit identical to that shown in FIGS. 1 and 2. Elements previously identified in FIGS. 1 and 2 retain their prior numeration. Rather than the single solar panel shown in FIGS. 1 and 2, access point 250 includes a pair of solar panels 252 and 254 that are connected by hinges, 256 and 258. The extra solar panel 254 provides additional electrical energy to be stored by charge storage assemblies, such as batteries 44 and 46 contained within base unit 12 and batteries 48 and 50 connected to base unit 12, as in FIG. 2. Also attached to base unit 12 is a second antenna, 260, attached to antenna connector 24. As noted above in connection with FIG. 1, antenna 16, which is associated with radio 70, may send and receive data in the 2.4 GHz frequency band, while antenna 260 associated with radio 74 may send and receive data in the 5.0 GHz frequency band.

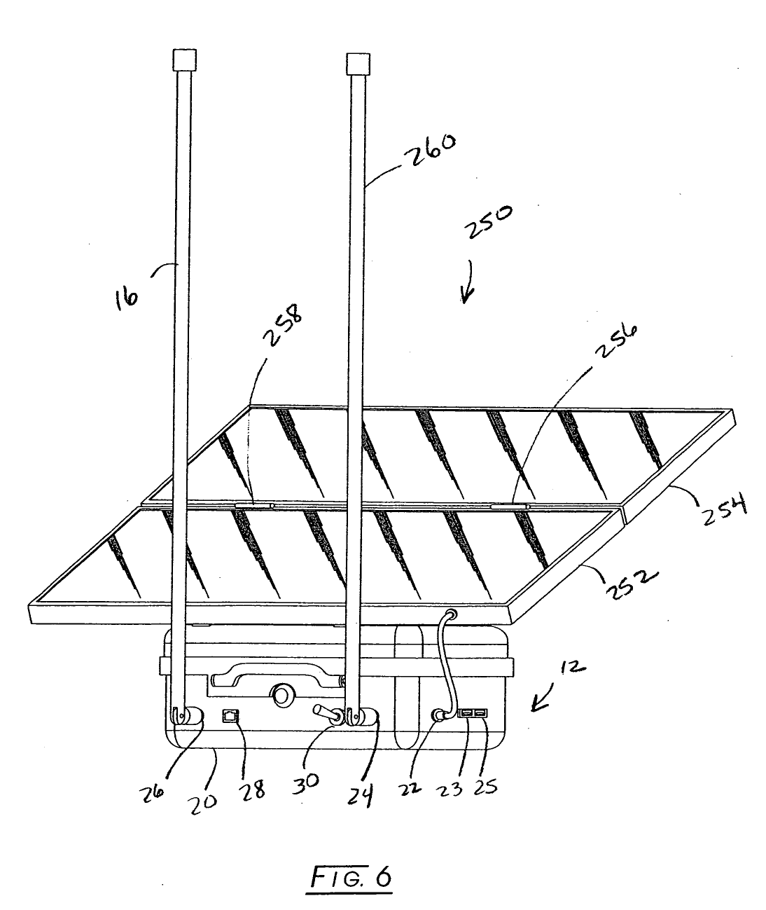

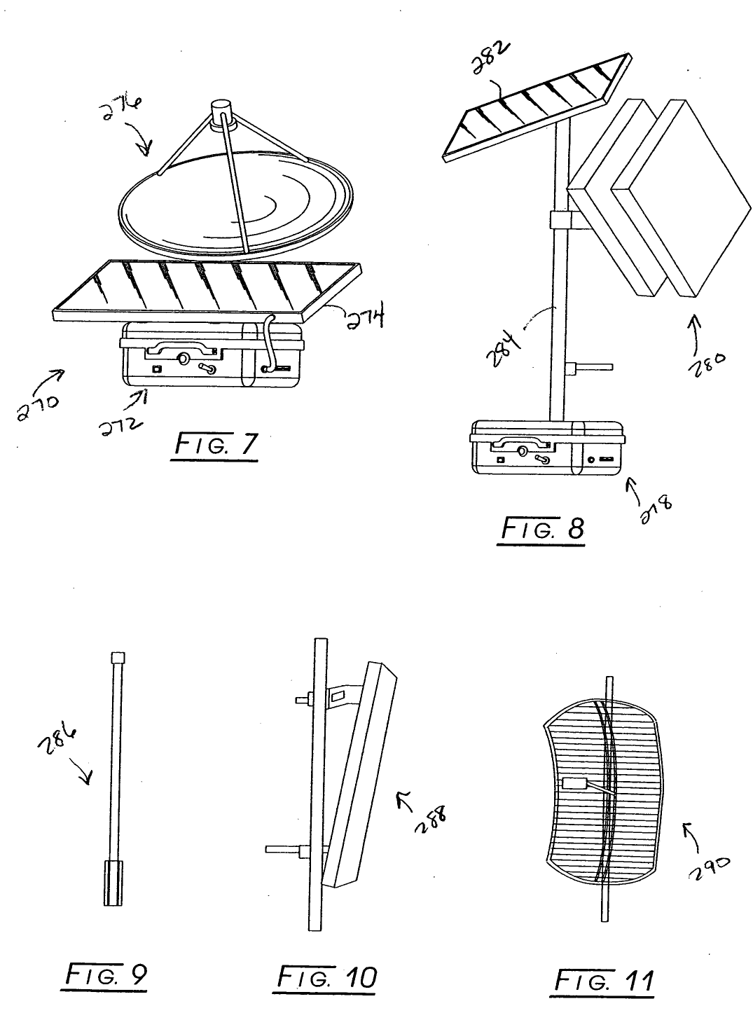

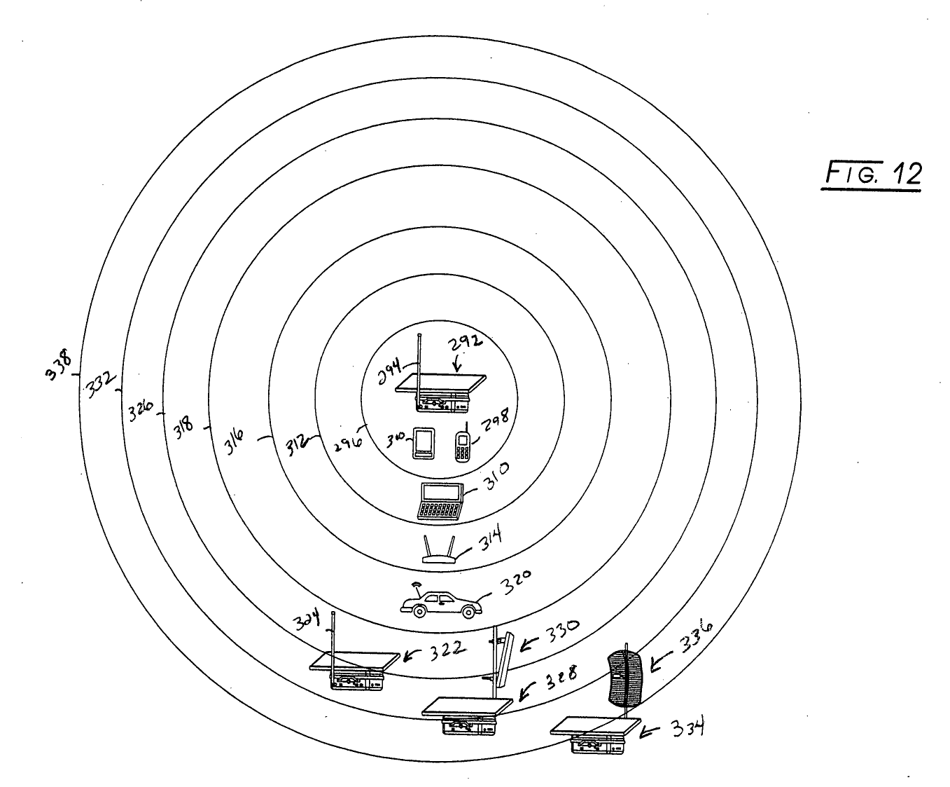

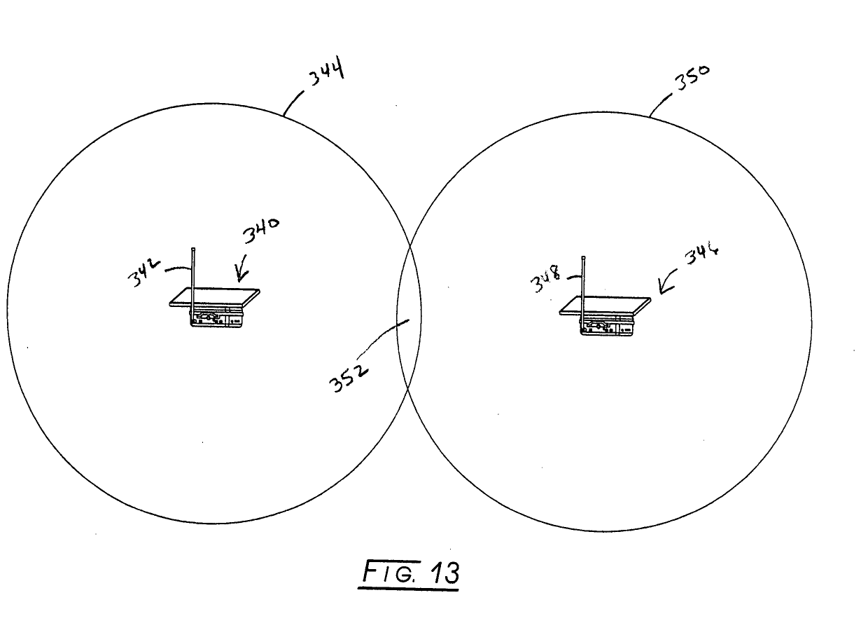

FIGS. 7-11 illustrate different conventional antenna devices that may be used for transmitting data among the access points. By selecting the appropriate number and type of antennas, any proposed network can be customized for a given geographic area and the expected usage. FIG. 7 shows an access point, 270, having a base unit, 272, a solar panel, 274, and a satellite dish antenna, 276. Use of this embodiment is shown at 96 and 112 in FIG. 3. With a satellite connection, the wireless network can communicate with a wired network or another wireless network located anywhere in the world. FIG. 8 shows an access point, 278, connected to a back haul, 280. A solar panel, 282, is seen attached to backhaul mast, 284. A back haul conventionally is used to transmit data over long distances, e.g., from a remote site to a network backbone. FIG. 9 shows an omni-direction antenna, 286, which, as noted above, radiates power uniformly in all directions. FIG. 10 is a sector antenna, 288, the coverage area of which is determined by the antenna's beam width in the horizontal plane. Geometrically, the area in which a sector antenna radiates energy is often shaped like a slice of pie. FIG. 11 is a directional antenna, 290, that receives or sends signals most effectively in a particular direction.

FIG. 12 illustrates the coverage area provided by an access point, 292, having an omni-directional antenna, 294. The innermost concentric circle, 296, represents the coverage area for wireless devices, or stations, such as cell phones, 298, and PDAs, 300, which typically include very short range internal antennas. The coverage area for these devices is about a ¼ of a mile. For other wireless devices including a 1 dB antenna, such as laptop, 310, the coverage area increases to about 1 mile as indicated by circle, 312. A number of external antennas are available on the market to increase or extend the coverage area for wireless devices. For wireless devices using a 2 dB external antenna, 314, the coverage area generated by access point 292 will be about 3 miles. To extend the coverage to 5 miles as at 318, a 5 dB antenna may be used. Such an antenna may be, for example, attached to the roof or trunk of a car, 320. The four innermost circles, 296, 312, 316 and 318 together generally are referred to as the client range. Thus, access point 292 will have a client range of about 5 miles.

The last three concentric circles illustrate the distances at which access point 292 can communicate with other access points having various antennas. For an access point, 322, having an omni-directional antenna, 324, the coverage area may be about 10 miles as indicated at 326. Because the omni-directional antenna radiates in all directions, its range is the shortest of the three access point antennas. For access point 328 with sector antenna 330, the coverage area will be about 12 miles as at 332. Finally, access point 334 includes directional antenna 336. As the most focused of the access point antennas, its coverage range is the greatest at about 18 miles as indicated by outer circle 338.

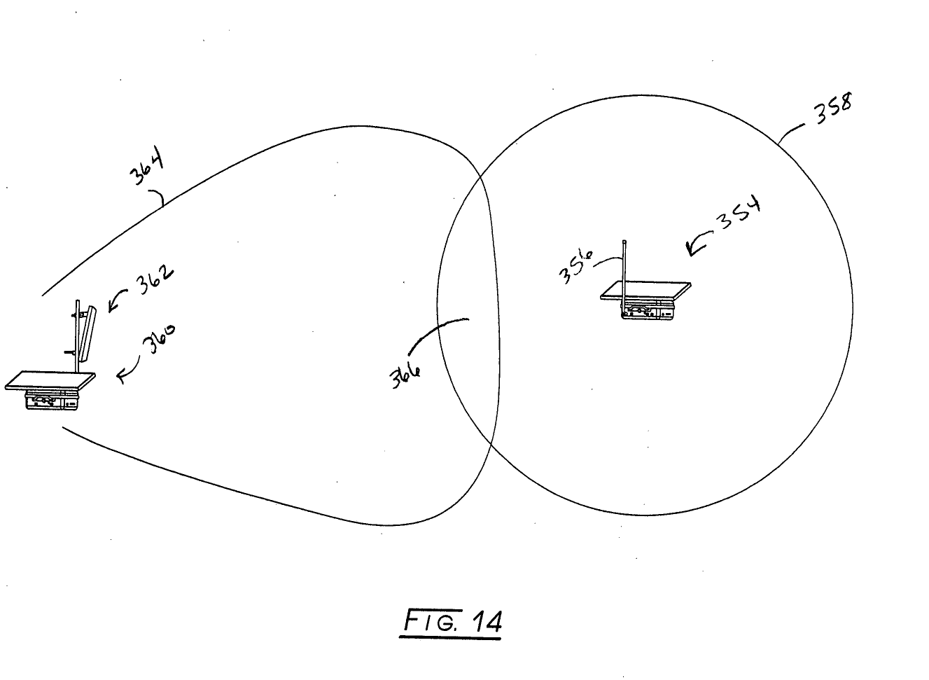

FIG. 13 illustrates the extended service area generated by a pair of portable solar powered access points, each connected to an omni-directional antenna. A first access point, 340, having an omni-directional antenna, 342, generates a first basic service area represented by circle 344. In like fashion, a second access point, 346, with omni-directional antenna 348, generates a second basic service area, 350. The client range of each basic service area will be about 5 miles. Service areas 344 and 350 together represent the extended service area of these two access points. In order for access points 340 and 346 to be able to communicate with one another, there must be an area of overlap in the basic service areas, as at 352. Since each access point has a basic service area range of about 5 miles, this overlap can occur when access points 344 and 350 are located approximately 10 miles apart as is also illustrated at circle 326 in FIG. 12. With this configuration, any wireless device located in basic service area 344 can transmit voice or data to any other wireless device in service area 344, and any wireless device in service area 350 can transmit voice or data to any other wireless device in service area 350. Because of overlap 352, any wireless device in service set 344 can communicate with any wireless device in service set 350 and vice versa. For example, if a wireless device wishes to communicate with a wireless device in service area 350, the data is first transmitted from the wireless device in service area 344 to access point 340. Access point 340 transmits the data to access point 346, which then send the data to the wireless device in service set 350. FIG. 14 illustrates the extended service area generated by an access point with an omni-direction antenna and an access point with a sector antenna. As with the access points in FIG. 13, access point 354 includes omni-directional antenna 356 which generates a basic service area indicated at 358, which has a client range of about 5 miles. Access point 360 includes a sector antenna, 362, having a more directional output than the omni-directional antenna resulting in a basic service area having the shape indicated at 364. Service area 364 will have a greater range than service area 358, for example, about 7 miles. As such, the distance between access points 358 and 364 will be about 12 miles to obtain the necessary overlap indicated at 366. This is also shown at 322 in FIG. 12.

FIG. 15 illustrates the transmission of a data between two backhauls. Access point 370 includes a backhaul 372, while access point 374 includes a backhaul 376. Backhauls 372 and 376 function to both send and receive data as indicated by bi-directional arrow 378. As noted above, a back haul generally is used to transmit data over a relatively long range. For example, back hauls 372 and 376 may be positioned approximately 40 miles apart.

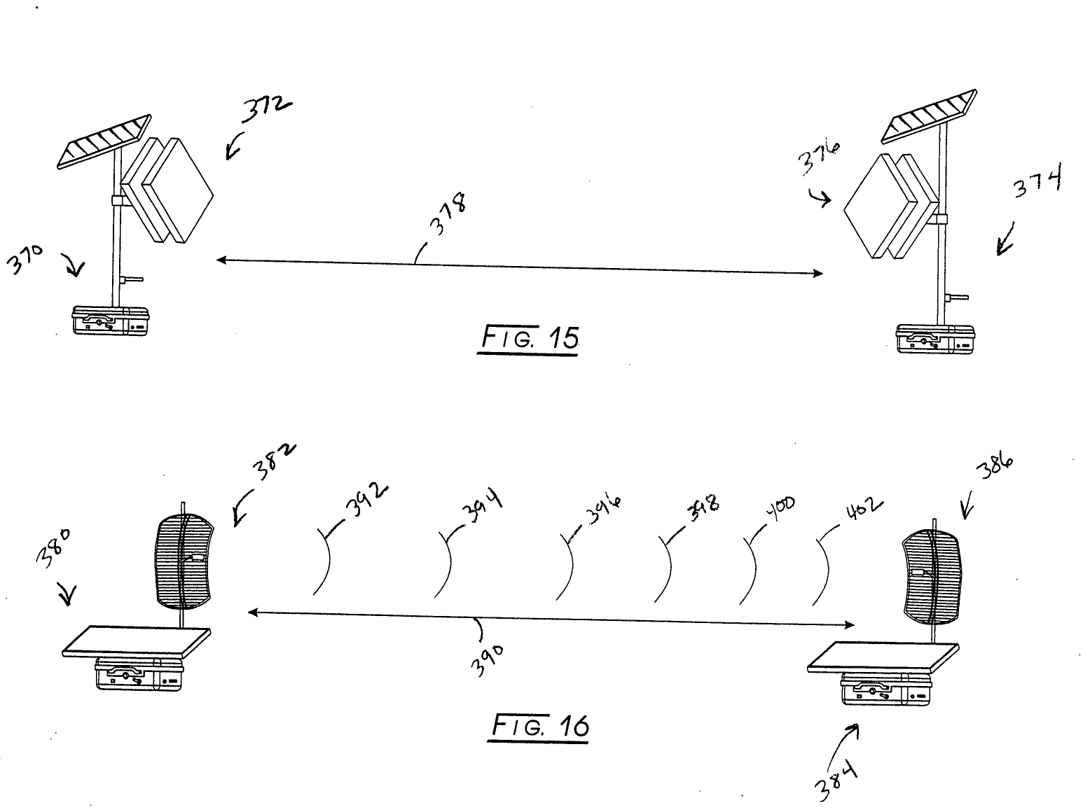

FIG. 16 illustrates another long range configuration utilizing a pair of portable solar powered access points with directional antennas. Access point 380 includes a directional antenna 382. Similarly, access point 384 is seen to include a directional antenna 386. The range between access points 380 and 384 generally will be about 20 miles. Directional antennas 382 and 386 both send and receive data as indicated by bi-directional arrow 390. When designing a wireless network, the transmission speed of the data is also a factor that must be considered. While directional antennas are capable of transmitting data over long distances, that distance affects the speed at which the data is transmitted. Arced lines 392 to 402 represent the speeds at which data travels as it is sent, for example, from access point 380 to access point 384. As the data leaves access point 380, it may be transmitted at a speed of 54 megabits per second (Mbps) as at 392. As the data travels farther away to the location indicated by 394, the transmission speed slows to 36 Mbps. By point 396, the transmission rate has slowed to 18 Mbps. At 398, the transmission speed is now 9 Mbps. That rate further decreases to 6 Mbps at 400 and 2 Mbps at 402. Finally, as indicated at 402, the data is traveling at a much reduced rate of 1 Mbps.

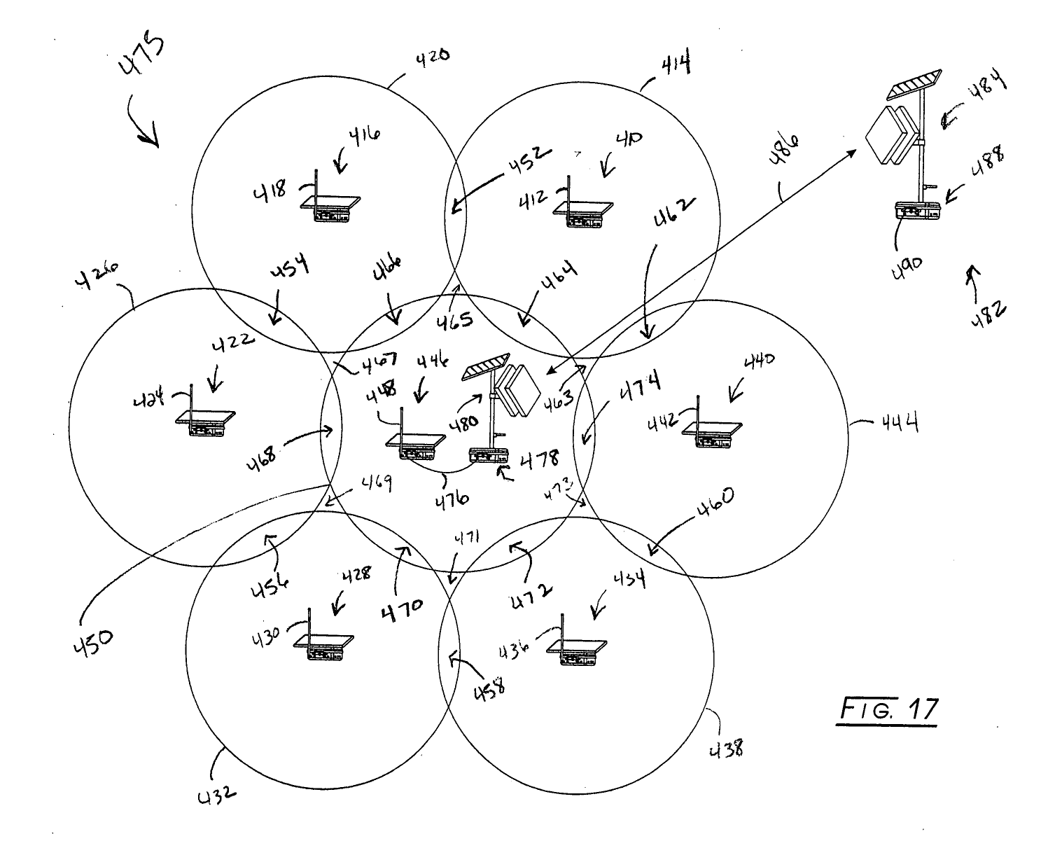

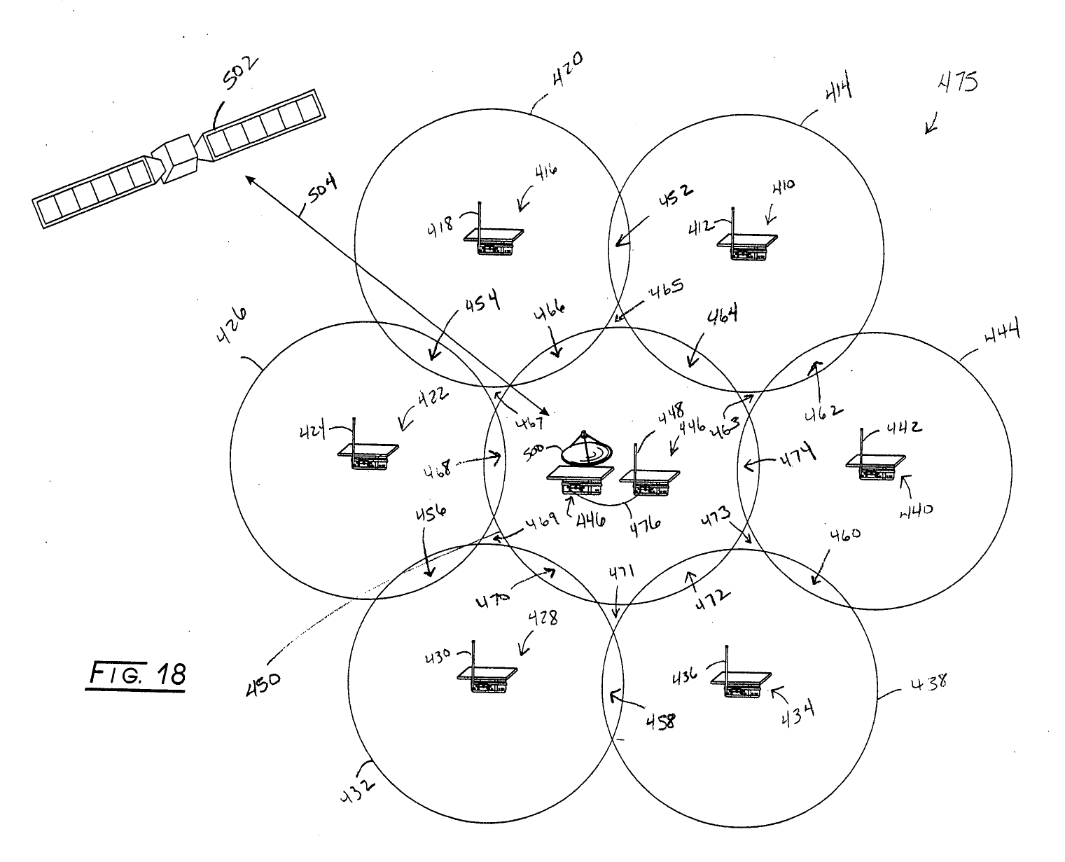

FIG. 17 illustrates a slightly more complicated wireless network including 7 access points with omni-directional antennas in combination with a pair of back hauls. As in previous figures, access point 410 includes omni-directional antenna 412 and generates basic service area 414. Access point 416 includes omni-directional antenna 418 and generates basic service area 420. Service sets 414 and 420 overlap as indicated at 452. Access point 422 includes omni-directional antenna 424 and generates basic service area 426. As with the previous two access points, the service sets 420 and 426 overlap as indicated at 454. Access point 428 includes omni-directional antenna 430 and generates basic service area 432. Service set 432 overlaps with service set 426 as indicated at 456. Access point 434 includes omni-directional antenna 436 and generates basic service area 438. Service set 438 overlaps with service set 432 as indicated at 458. Access point 440 includes omni-directional antenna 442 and generates basic service area 444. The service sets of access points 434 and 440 overlap as indicated at 460. Lastly, access point 446 includes omni-directional antenna 448 and generates basic service area 450. Service area 450 of access point 446 overlaps with all six surround service areas as indicated at 464, 466, 468, 470, 472 and 474. The extended service area created for this network, and indicated generally at 475, includes the basic services sets of all seven access points. Extended service area 475 includes six small gaps, 463, 465, 467, 469, 471, and 473, where no service would be available. These areas can easily be eliminated by moving the seven access points closer together or adding additional access points at those locations.

Connected to access point 446 by cable 476 is another access point 478. Access point 478 is connected to a back haul 480 which transmits data as previously described in FIG. 15 to another access point 488 having a back haul 484. Back haul 484 may be connected to a backbone, i.e., an existing wired network, via a Category 5 cable affixed to RJ-45 connector 490 on base unit 488. This connector was previously described at FIG. 1 above. With this configuration, extended service area 475 acts as an extension of the wired network connected at 490.

In extended service area 475, a mobile wireless device can travel from any basic service area to another without disruption of transmission. When the mobile wireless device enters-a new service area, for example, leaving service area 414 and entering service area 420, the mobile wireless device associates with the new access point 416. Each of the access points includes a wireless distribution system (WDS) that acts as the distribution system medium which in conjunction with the backbone network forms the distribution system for the network. The network distribution system controls the flow of data among access points to ensure that data is sent to the proper access point for transmission to the recipient wireless device.

FIG. 18 shows the network of FIG. 17 with an alternate satellite connection to the backbone network. In place of back hauls 480 and 484, this network configuration utilizes a satellite dish antenna, 500, which communicates with an orbital satellite 502. Satellite antenna 500 is able to send and receive signals from satellite 502 as indicated by bi-directional arrow 504. To make the backbone connection, satellite 502 communicates with a satellite antenna (not shown) located at and connected to the wired network.

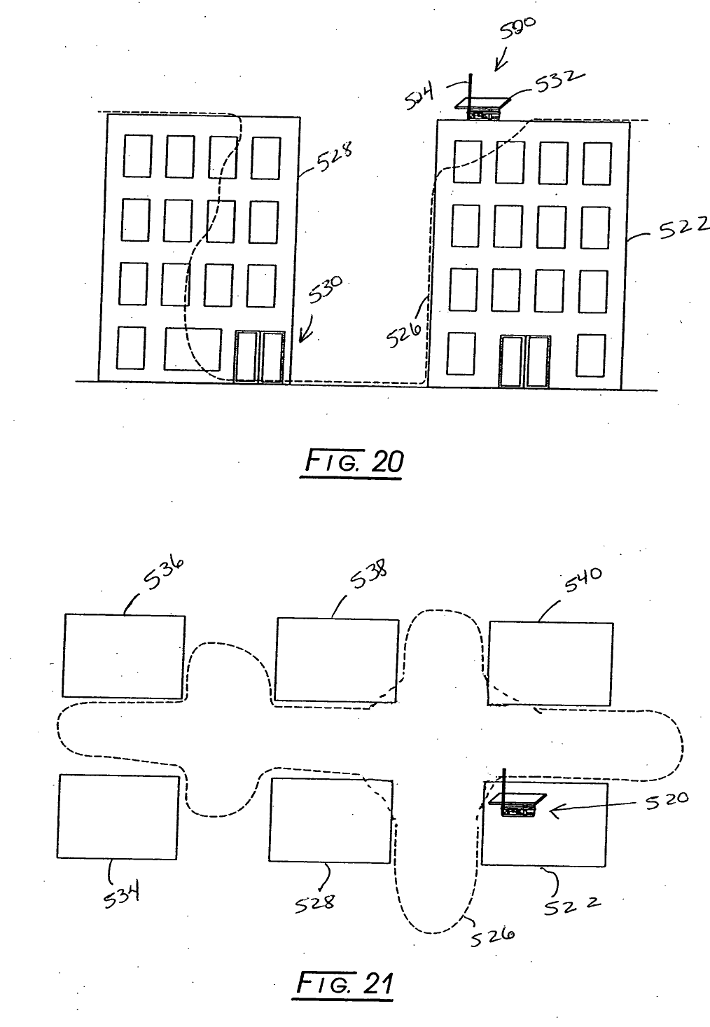

FIG. 19 shows yet another embodiment of the network established in FIG. 17, with communications to the backbone network provided by a pair of directional antennas. In FIGS. 17 and 18, the back haul and satellite antenna required connection to a designated access point. When using a directional antenna, as in FIG. 19, a single access point can support both an omni-directional antenna for creating the basic service area and a directional antenna to relay communications to the backbone network. For example, access point 446 is seen to support an omni-directional antenna 448 which generates basic service area 450. Access point 446 also supports a directional antenna, 504, which communicates with a second directional antenna, 508, connected to access point 506. Directional antennas 448 and 504 both send and receives data as indicated by bi-directional arrow 510. Directional antenna 508 is connected to the antenna connector (FIG. 1) of access point 506. Access point 506 also may be connected to the backbone network via a Category 5 cable connected to RJ-45 connection 514 of base unit 512.

When establishing a wireless network, a designer must take into account the budget available, the service area desired, the expected number of users, the type of usage (e.g., data, voice, etc.), and so on. Using the different antenna types and selecting the appropriate number of access points, the designer can create a wireless network to suit the requirements and constraints of the project.

Advancements in wireless technology have spurred the demand for publicly available wireless locations, the so-called “hot spots.” Hot spots have been established by retailers, such as coffee houses and bookstores, to provide Internet access for its patrons. Hot spots also have been established in parks, libraries, and other public places. On-line directories of hot spot locations have been compiled to enable owners of wireless devices to locate hot spots.

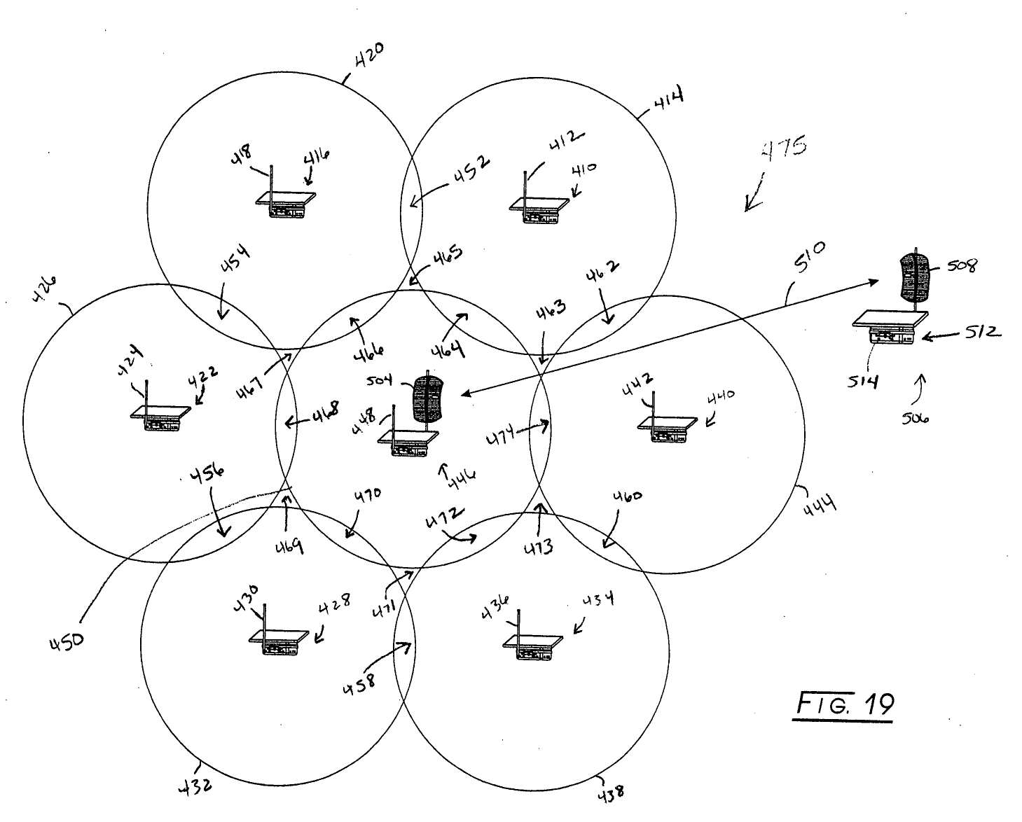

In the previous examples, wireless networks have been illustrated with a plurality of solar powered access points. Alternatively, a single solar powered access point also may be used to quickly and easily establish a hot spot. Looking to FIG. 20, a solar powered access point is shown generally at 520 located atop a building 522. Access point 520 includes an omni-directional antenna, 524 that generates a basic service area, a potion of the edges of which is identified by dashed line 526. The basic service area extends between building 522 and a second building, 528. Because the signals generated by access point 520 are near-line of sight, a portion of the signal will penetrate building 528. Thus, access point 520 is advantageously positioned to establish a hot spot, for example, in the location indicated generally at 530 while maximizing the energy generation of solar panel 532. FIG. 21 is a top view showing the basic service set generated by access point 520 among six buildings, 522, 528, 534, 536, 538, and 540.

While the invention has been described with reference to various embodiments, those skilled in the art will understand that various changes may be made and equivalents may be substituted for elements thereof without departing from the scope and essence of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims. In this application all units are in the metric system and all amounts and percentages are by weight, unless otherwise expressly indicated. Also, all citations referred herein are expressly incorporated herein by reference.

I claim

1. A method for establishing a portable solar powered wireless communications network within a given region for generating an extended service area in association with an existing wired communications network to enable communications among wireless devices located within said given region, comprising the steps of:
(a) providing a first solar powered access point capable of sending and receiving radio transmissions within a first basic service -area and connectable to said wired communications network;
(b) connecting said first solar powered access point to said wired network;
(c) providing a plurality of solar powered access points, each capable of sending and receiving radio transmissions within a basic service area;
(d) positioning said plurality of solar powered access points within said given region, said basic service areas of said first solar powered access point and said plurality of solar powered access points overlapping to define an extended service area; and
(e) providing a wireless distribution system associated with said first solar power access point and said plurality of solar powered access points for controlling radio transmissions within said extended service area.

2. The method of claim 1, wherein said first solar powered access point and said plurality of solar powered access points are each provided comprising,
(i) a solar panel capable of generating electrical energy;
(ii) a base unit having a connector for connecting said solar panel to said base unit, one or more charge storage assemblies for storing electrical energy received from said solar panel, a charge controller for controlling charge received by said charge storage device, an access point, a voltage control device for controlling the flow of charge from said charge storage device to said access point, an antenna connector, and a wired communications network connector; and
(iii) an antenna connected to said antenna connector of said base unit for sending and receiving radio transmissions within a basic service area.

3. The method of claim 1, wherein said given region comprises a disaster region.

4. A method for establishing a portable solar powered wireless communications network within a disaster region for generating an extended service area in association with an existing wired communications network to enable communications among wireless devices located within the disaster region, comprising the steps of:
(a) providing a plurality of solar powered access points, each access point comprising,
(i) a solar panel capable of generating electrical energy;
(ii) a base unit having a connector for connecting said solar panel to said base unit, one or more charge storage assemblies for storing electrical energy received from said solar panel, a charge controller for controlling charge received by said charge storage device, an access point, a voltage control device for controlling the flow of charge from said charge storage device to said access point, an antenna connector, and a wired communications network connector; and
(iii) an antenna connected to said antenna connector of said base unit for sending and receiving radio transmissions within a basic service area;
(b) storing said plurality of solar powered access points in a storage facility, said solar powered access points being connected to a charge maintenance assembly to maintain the charge of said charge storage device during storage;
(c) transporting said plurality of portable access devices to said disaster region;
(d) connecting a first solar powered access point to said wired communications network;
(e) positioning a plurality of said solar powered access points within said disaster region, said basic service areas of said first solar powered access point and said plurality of solar powered access points overlapping to define an extended service area; and
(f) providing a wireless distribution system associated with said first solar power access point and said plurality of solar powered access points for controlling radio transmissions within said extended service area.

5. The method of claim 4, wherein said charge maintenance assembly comprises one or more trickle chargers.

6. A portable solar powered wireless communications network system for generating an extended service area in association with an existing wired communications network to enable communications among wireless devices located within a given region, comprising:
(a) a plurality of solar powered access points, each access point comprising,
(i) a solar panel capable of generating electrical energy;
(ii) a base unit having a connector for connecting said solar panel to said base unit, one or more charge storage assemblies for storing electrical energy received from said solar panel, a charge controller for controlling charge received by said charge storage device, an access point, a voltage control device for controlling the flow of charge from said charge storage device to said access point, an antenna connector, and a wired communications network connector; and
(iii) an antenna connected to said antenna connector of said base unit for sending and receiving radio transmissions within a basic service area; and
(b) a charge maintenance assembly connectable to each said base unit of said plurality of solar powered access points for maintaining the electrical energy stored in each said one or more charge storage assemblies.

7. The portable solar powered wireless communications network system of claim 6, wherein said charge maintenance assembly comprises one or more trickle chargers.

8. The portable solar powered wireless communications network system of claim 6, wherein said one or more charge storage assemblies comprise one or more batteries.

9. The portable solar powered wireless communications network system of claim 6, wherein said antenna comprises one or more of a directional, omni-directional sector, and satellite antenna.
